(19) United States
(12) Patent Application Publication
(10) Pub. No.: US 2011/0051393 A1
(43) Pub. Date: Mar. 3, 2011

(54) DISPLAY DEVICE

(75) Inventors: Kohki Ishikawa, Tokyo (JP); Kiyotsugu Oba, Tokyo (JP); Mitsuru Kamikatano, Tokyo (JP); Kiyoshi Ina, Saitama (JP)

(73) Assignees: FUJIKURA LTD., Tokyo (JP); CALSONIC KANSEI CORPORATION, Saitama-shi, Saitama (JP)

(21) Appl. No.: 12/988,189

(22) PCT Filed: Apr. 16, 2009
(86) PCT No.: PCT/JP2009/057692

§ 371 Date: Oct. 15, 2010

(30) Foreign Application Priority Data
Apr. 17, 2008 (JP) 2008-108211

(51) Int. Cl. G01D 11/28

(52) U.S. Cl. 362/29

(57) ABSTRACT

Both end portions of a light guide body (3) are bent in respective directions towards a second main surface to form guide portions (31, 32). Light that is emitted from each light source (4, 5) mounted on a wiring board arranged on the rear side of the light guide body and that travels in a direction vertical to main surfaces of the light guide body is guided by each guide portion (31, 32) into light propagating in a direction along the main surfaces of the light guide body. Reflection surfaces of a plurality of grooves (13) formed on the light guide body radially from the center position thereof reflect the light from the light sources to a dial plate (2) side and a diffusion printing diffuses the reflected light, so that the diffused light transmissively illuminates a scale marks section (21) and a numerical characters section (22) of the dial plate with uniform brightness.

### BACKGROUND OF THE INVENTION

### Technical Field of the Invention

The present invention relates to a display device suitable to be adopted as indicators of vehicles and the like.

A display device used as an indicator for vehicles has scale marks and/or numerical characters arranged in a circular arc fashion, for example, along the rotation of a pointer and at the outer circumference of a dial plate. A plurality of light sources may also be arranged in a circular arc fashion behind the scale marks and/or numerical characters thereby transmissively illuminating them.

In order for less light sources to transmissively illuminate a dial plate in homogeneous illumination, there is proposed a technique using a transmissive light guide plate provided behind the dial plate, which guides light from light sources to the dial plate thereby transmissively illuminating the dial plate (Patent Document 1).

### [Patent Document 1] Japanese Patent Application Publication (Kokai) 2007-139791

### SUMMARY OF THE INVENTION

The above technique disclosed in Patent Document 1 involves a horizontal emission type LED (Light Emitting Diode) mounted on a printed circuit board which forms an electrical circuit unit of an indicator for vehicles. The LED emits light in a horizontal direction relative to the mounting surface thereof, and the emitted light is incident onto an end edge of the light guide plate. However, the horizontal emission type LED has more complex structure than that of a vertical emission type LED which emits light in a vertical direction relative to the mounting surface, thereby being expensive. Instead, a cheap vertical emission type LED may be attempted to be used as a light source for emitting light to be incident onto the end edge of the light guide plate. In this case, however, an additional circuit board is required for the light source, and as such the structure becomes to be complicated.

The object of the present invention is to provide a display device in which a cheap light source is available and the structure is prevented from being complicated.

The display device according to the present invention comprises: a light-transmissive dial plate having an indicative section arranged in a circular arc fashion; a light guide body formed in a circular arc shape and located at a rear surface side of the dial plate so as to cover the indicative section, the light guide body having a first main surface that faces the dial plate and a second main surface that is an opposite surface of the first main surface, the second main surface being formed with a plurality of groove regions each having a reflecting surface so as to be radially from a center position of the circular arc shape; and at least one light source mounted on a wiring board located at a side of the second main surface of the light guide body and emitting light in a substantially vertical direction relative to a mounting surface of the wiring board,

and is characterized in that the light guide body has a guide portion formed at at least one end portion of the light guide body, the guide portion receives, at an entrance face, light emitted from the light source and propagating in a substantially vertical direction relative to the first main surface and the second main surface of the light guide body, and guides the received light into light propagating in a direction along the first main surface and the second main surface of the light guide body, and the reflecting surface of each groove region reflects light from the light source to a side of the first main surface of the light guide body.

In the above-described display device, the guide portion may be formed by bending the end portion of the circular arc shaped light guide body toward the second main surface, and the entrance face may be formed at an end of the guide portion so as to be a plane substantially perpendicular to an optical axis direction of the light source.

In the above-described display device, a surface of the guide portion corresponding to the first main surface may be formed with faces each having a certain angle of a critical angle or more to outer air.

In the above-described display device, an area on the rear surface of the dial plate corresponding to the indicative section may be treated with diffusion printing to diffuse light emitted from a surface of the light guide body.

In the above-described display device, the reflecting surface may be configured as an inclined surface of a V-shaped groove region formed at the second main surface of the light guide body.

In the above-described display device, the grooved region may be configured as a groove continuously formed in a width direction of the light guide body.

In the above-described display device, the grooved region may be formed across the width direction of the light guide body.

In the above-described display device, the V-shaped groove region may be formed such that a depth thereof increases in accordance with an increase of a distance from the light source.

In the above-described display device, the light source may comprise a first light source and a second light source different from the first light source, and the light guide body may be configured to have a first entrance face on which light from the first light source is incident and a second entrance face on which light from the second light source is incident.

In the above-described display device, the reflecting surface of each groove region may be formed such that the reflecting surface reflects light from either one of the first light source and the second light source, which is relatively close to the reflecting surface in a distance via the light guide body, toward the first main surface.

According to the present invention, because light from a vertical emission type light source is deviated by the guide portion, a display device in which a cheap light source is available and the structure is prevented from being complicated can be provided.

### BRIEF DESCRIPTION OF DRAWINGS

FIG. 1 is a partial plan view illustrating a combination meter to which an embodiment of the present invention is applied.

FIG. 2 is a sectional view along the line A-A of FIG. 1.

FIG. 3 is a plan view illustrating a light guide body of FIG. 1.

FIG. 4 is a perspective view of the light guide body of FIG. 1.

FIG. 5 is a perspective view of an end portion of the light guide body of FIG. 1.

FIG. 6A is a partial sectional view illustrating one groove region of the light guide body of FIG. 1.

FIG. 6B is a partial sectional view illustrating groove regions of the light guide body of FIG. 1.

### DESCRIPTION OF THE PREFERRED EMBODIMENT

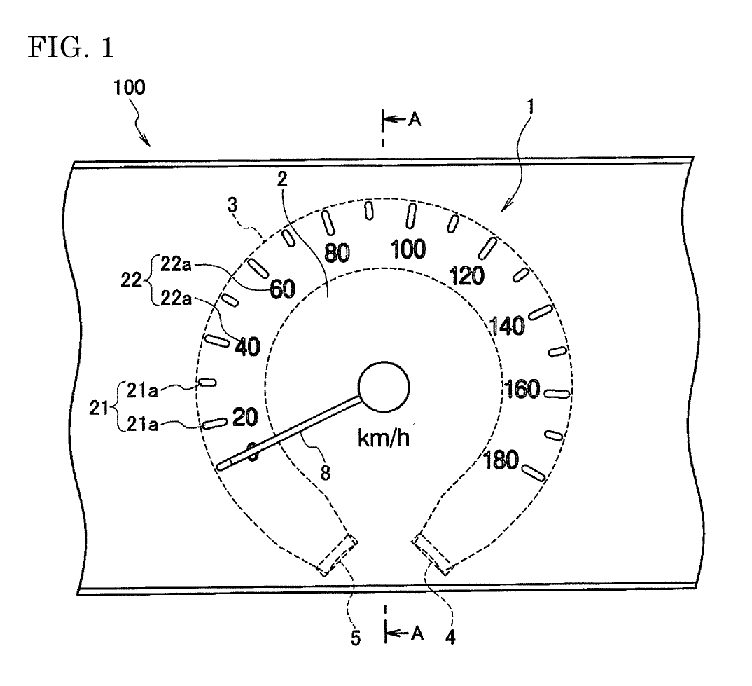

A display device 1 according to the present embodiment is to be embedded into a combination meter 100. The combination meter 100, which is provided at a position in front of the driver's seat of a motor vehicle and capable of being visually recognized by a driver, comprises a plurality of indicators and the like, and visually represents various kinds of information regarding the motor vehicle for the driver. FIG. 1 depicts an example of a speedometer to which the display device 1 according to the present embodiment is applied.

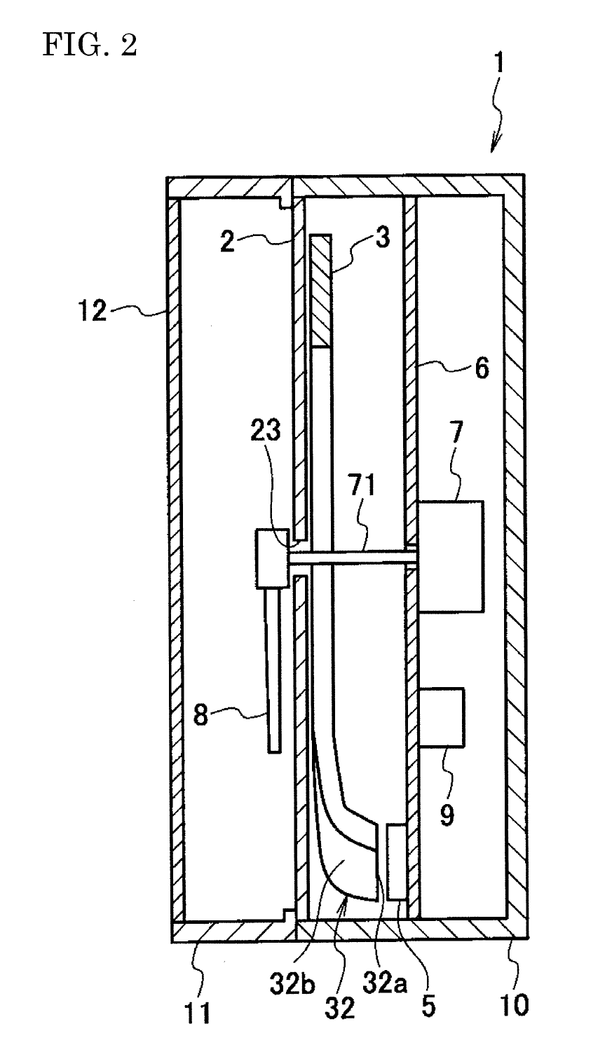

As shown in FIG. 1 and FIG. 2, the display device 1 according to the present embodiment comprises a dial plate 2, a light guide body 3, light sources 4 and 5, a printed circuit board 6, a movement 7, a pointer 8, a controller 9, a case 10, facing plates 11, and a front face cover 12.

The dial plate 2 is formed of a thin plate of light-transmissive material, such as acrylic resin and polycarbonate resin, on which an indicative section is formed to be arranged in a circular arc fashion. More specifically, as shown in FIG. 1, the dial plate 2 is formed with a scale marks section 21 which comprises a plurality of scale marks 21a arranged in a circular arc fashion and a numerical characters section 22 which is allocated at inner area of the scale marks section 21 and comprises a plurality of numerical characters 22a also arranged in a circular arc fashion and concentrically with the scale marks section 21.

The scale marks section 21 and numerical characters section 22 are formed by performing printing, hot stamping, or the like on the front surface or the rear surface of the dial plate 2. More specifically, a colored layer having a light-intransmissivity is provided on an area other than the scale marks section 21 and numerical characters section 22, and the scale marks section 21 and numerical characters section 22 remain transparent or are treated with a semi-transparent layer and the like.

In addition, an area or areas on the rear surface of the dial plate 2 corresponding to the scale marks section 21 and numerical characters section 22 are treated with diffusion printing of white or smoky color in order to diffuse the light emitted from the surface of the light guide body 3.

The light guide body 3 is formed of a light-transmissive plastic material, such as transparent acrylic resin, polycarbonate resin, silicone resin, cyclo-polyolefin resin, and the like, in a plate-like form with thickness of approximately 1 mm to 3 mm, for example. As shown in FIG. 1 and FIG. 2, the light guide body 3 is formed as a circular arc shape in plane view and located at the rear surface side of the dial plate 2 so as to cover the scale marks section 21 and numerical characters section 22.

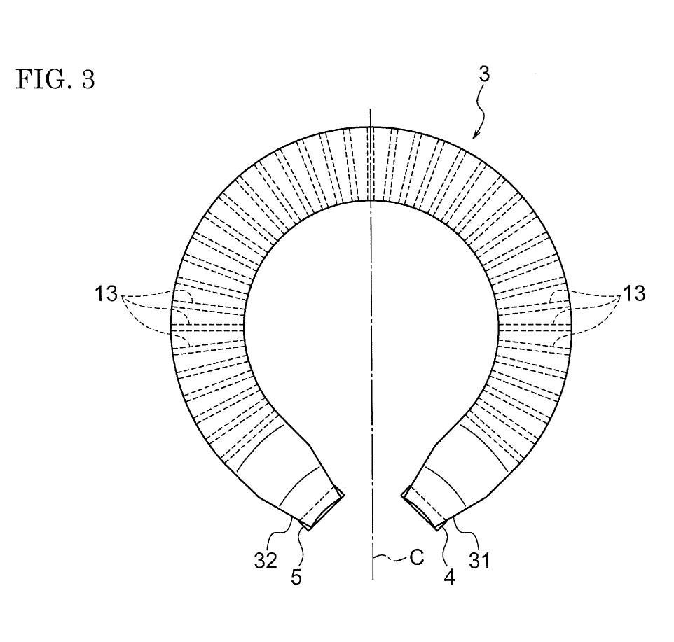

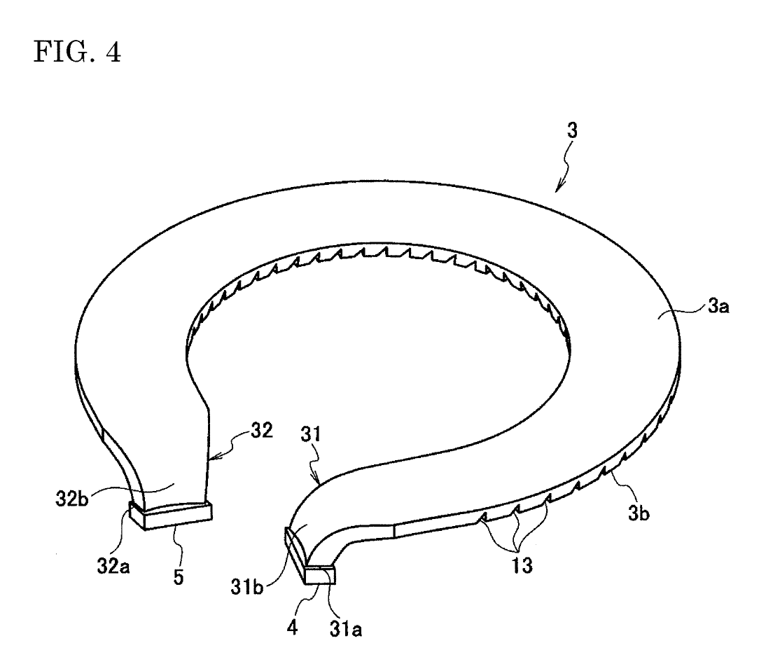

As shown in FIG. 3 to FIG. 5, the light guide body 3 has guide portions 31 and 32 formed by bending or folding back both respective end portions corresponding to both ends of the circular arc shape of the light guide body 3 toward a second main surface 3b. Entrance faces 31a and 32a to be respective entrances for light beams from the light sources 4 and 5 are provided at ends of the guide portions 31 and 32, respectively, so as to be respective planes approximately perpendicular to main optical axes directions of the light sources 4 and 5.

Respective top surfaces 31b and 32b of the guide portions 31 and 32 are formed with faces each having a certain angle of the critical angle or more from the inner regions of guide portions 31 and 32 to the outer air. As such, the guide portions 31 and 32 are capable of receiving respective light beams (light beams emitted from light sources 4 and 5 and propagating in directions approximately perpendicular to the first main surface 3a and second main surface 3b) at the entrance faces 31a and 32a, reflecting the received light beams at top surfaces 31b and 32b, and thereby guiding the reflected light beams into light beams propagating in directions along the first main surface 3a and second main surface 3b of light guide body 3 without leaking them outwards.

The entrance faces 31a and 32a respectively have long sides 31c and 32c curved smoothly towards the centers thereof so as to correspond to the luminous flux distributions of the light beams emitted from light sources 4 and 5. Therefore, incident efficiencies of light beams from the light sources 4 and 5 to the light guide body 3 can be improved.

In turn, a plurality of groove regions 13 are formed radially from the center position of the circular arc shape in plane view of the light guide body 3, almost entirely in the circumferential direction thereof, and in predetermined angular intervals on the second main surface 3b of light guide body 3, which is the opposite surface of a first main surface 3a facing to the dial plate 2. Each groove region 13 has an approximately V-shaped cross section and is formed across the width direction of light guide body 3. The predetermined angular intervals may be designed as two degrees, for example.

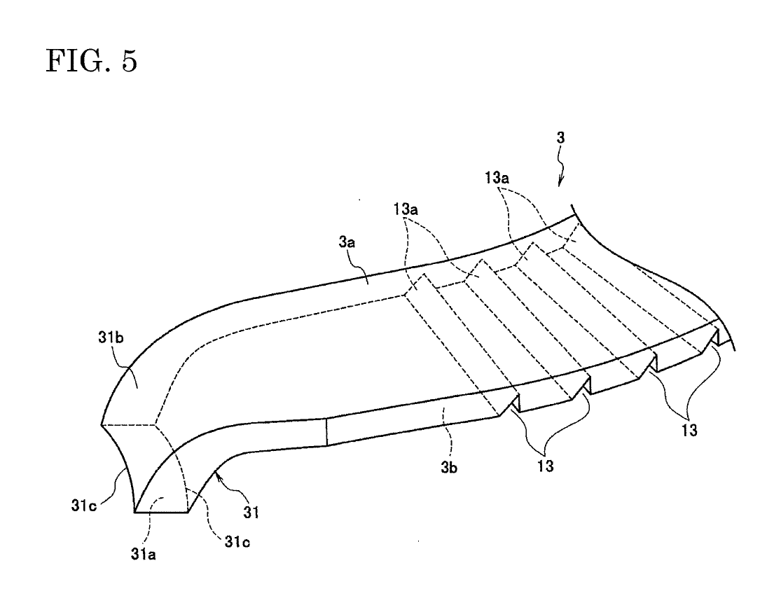

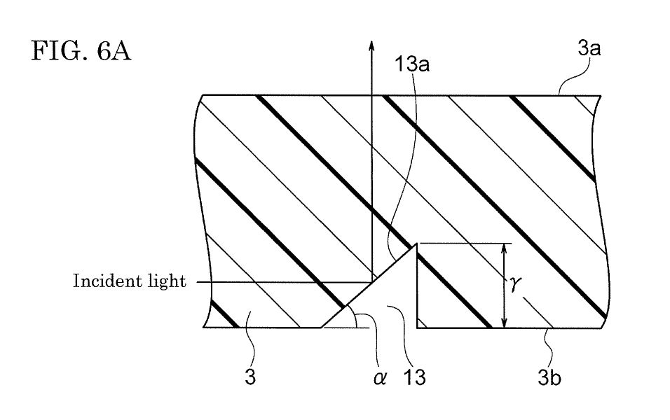

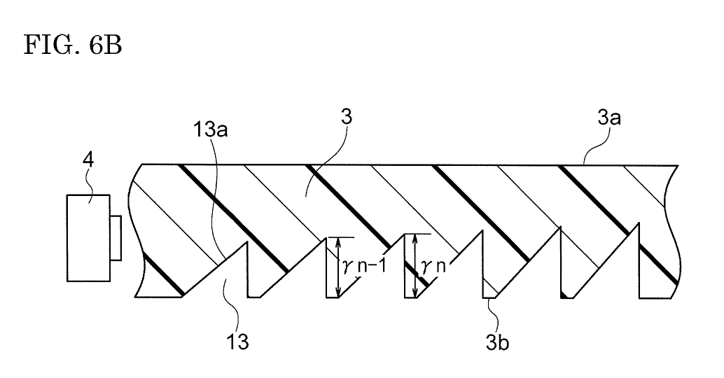

As shown in FIG. 5, a reflecting surface 13a is formed on one face of each groove region 13 across the width direction of light guide body 3. The reflecting surface 13a is to reflect the light propagating in light guide body 3 toward the first main surface 3a side, and is structured as being inclined at a predetermined inclination angle of a relative to the second main surface 3b, as shown in FIG. 6A. By forming the reflecting surfaces 13a of groove regions 13 across the width directions of light guide body 3, ununiformity of light emitting luminance on the dial plate 2 can be suppressed from occurring.

Each reflecting surface 13a is formed such that light from either one of the light sources 4 and 5 is reflected toward the first main surface 3a side of light guide body 3. For example, each of the groove regions 13 arranged at the light source 4 side relative to the center line C shown in FIG. 3 (the right-hand side in FIG. 3) is formed such that the reflecting surface 13a faces toward the light source 4, which is a light source relatively close to that groove region 13 in a distance via light guide body 3, and reflects light from the light source 4 toward the first main surface 3a, while each of the groove regions 13 arranged at the light source 5 side relative to the center line C shown in FIG. 3 (the left-hand side in FIG. 3) is formed such that the reflecting surface 13a faces toward the light source 5, which is a light source relatively close to that groove region 13 in a distance via light guide body 3, and reflects light from the light source 5 toward the first main surface 3a.

If the inclination angle α of reflecting surface 13a is too small, then the inclination angle of the reflected light becomes to be large, thereby deteriorating the light emitting luminance at the time the dial plate 2 is squarely viewed. In contrast, if the inclination angle α is too large, then the incident angle of light exceeds the critical angle, thereby increasing the proportion of light transmitting through the reflecting surface 13a, decreasing the reflection efficiency, and deteriorating utilization efficiency of light.

In order to suppress such a deterioration of utilization efficiency of light, there is known a method where the emitting luminance is heightened by increasing the input power to the light sources 4 and 5. However, this method is not preferred because of causing an increase in power consumption and/or deterioration in lifetime of the light sources 4 and 5. Given the foregoing, the inclination angle α of the reflecting surface 13a is preferably in the range of 45 degrees to 60 degrees, and more preferably in the range of 50 degrees to 55 degrees. By setting the inclination angle α within such ranges, the reflection efficiency of light can be increased and the emitting luminance of the dial plate 2 can also be increased.

In the case where the reflecting surfaces 13a have the same inclination angle α, if heights of whole the groove regions 13 are the same as being γ (refer to FIGS. 6A and 6B), then the luminance of the reflected light from the groove region 13 located far from the light sources 4 and 5 is liable to be lower than that of the reflected light from the groove region 13 located near the light sources 4 and 5. Consequently, in the present embodiment, the larger the distance from the light source 4 to each groove region 13 arranged at the light source 4 side (the right-hand side in FIG. 3) is, the larger the height γ is set, while the larger the distance from the light source 5 to each groove region 13 arranged at the light source 5 side (the left-hand side in FIG. 3) is, the larger the height γ is set. This allows the reflected light quantity from each groove region 13 to be even, thereby enabling to obtain homogeneity in luminance. In other words, by providing a balance between that the light quantity decreases by attenuation in accordance with the increase in distance from the light source 4 or 5 and that the luminance of the reflected light is to be increased by stepwisely increasing the height γ in accordance with the increase in distance from the light source 4 or 5, the luminance within the relevant region may be even.

Although the production method of the light guide body 3 is not particularly limited, the light guide body 3 formed with grooved regions 13 is easily produced through metal molding and/or diamond bite cutting, possibly with cutting by heated edge, for example.

Light sources 4 and 5, each of which comprises one or more LEDs and the like, are mounted on the printed circuit board 6. The light sources 4 and 5 are arranged such that they emit respective light beams in directions opposite to the printed circuit board 6 side and that the emitted respective light beams are capable of being incident onto the entrance faces 31a and 32a. According to the present embodiment, a vertical emission type LED which emits light in an approximately vertical direction relative to the mounting surface of the printed circuit board 6 is available. For example, the light sources 4 and 5 are provided as two vertical emission type LEDs arranged in a direction along the entrance faces 31a and 32a.

The printed circuit board 6, which is a part of the electrical circuit unit of combination meter 100, is arranged behind the light guide body 3 (at the right-hand side of FIG. 2). The light sources 4 and 5, the movement 7 and the controller 9 are mounted on the printed circuit board 6.

The movement 7 is a rotational actuator which rotates a shaft 71 by a certain angle in response to an electrical signal from external. The shaft 71 of movement 7 is elongated to the front face side of dial plate 2 (the left-hand side of FIG. 2) through a penetrating hole 23 of dial plate 2, and fixed with the pointer 8 at the end thereof.

The pointer 8 is formed of a transparent or semi-transparent material, such as acrylic resin, and provided with light from an external light source, not shown, thereby luminously indicating itself.

The controller 9, comprising a hybrid IC and the like, controls lighting and turning off the lighting of the light sources 4 and 5. In addition, the controller 9 drives the movement 7 in response to the electrical signal from external thereby rotating the shaft 71 to a prescribed angle position.

The case 10 accommodates and holds the above-described dial plate 2, light guide body 3, light sources 4 and 5, printed circuit board 6, and other components.

The front face cover 12 is attached to the facing plates 11 at the front side of dial plate 2 (the left-hand side of FIG. 2). The front face cover 12 is formed of a transparent thin-plate like polycarbonate resin or the like, thereby maintaining a sufficient airtight structure.

Given the above structure of display device 1, when the controller 9 controls the light sources 4 and 5 to emit light beams, the guide portions 31 and 32 receive respective light beams at the entrance faces 31a and 32a and reflect the respective light beams at top surfaces 31b and 32b of the light guide body 3, thereby introducing the reflected light beams into light beams propagating in directions along the first main surface 3a and second main surface 3b within the light guide body 3. In turn, as the light propagates within the light guide body 3, almost the whole of light arrived at each reflecting surface 13a of the groove regions 13 is reflected by the reflecting surface 13a thereby being emitted from the first main surface 3a side to external space.

The light emitted from the first main surface 3a of light guide body 3 after being reflected by each reflecting surface 13a of the groove regions 13 is diffused by the diffusion printing applied to the area or areas corresponding to the scale marks section 21 and numerical characters section 22 on the rear surface of dial plate 2. This diffused light, which has homogeneous luminance at that area or areas, transmissively illuminates the scale marks section 21 and numerical characters section 22 of the dial plate 2 thereby providing luminescent display.

According to the present embodiment, the light from light sources 4 and 5 is reflected toward the dial plate 2 side by the plurality of reflecting surfaces 13a of the groove regions 13 formed on the light guide body 3 and radially from the center position thereof, and the reflected light is diffused by the diffusion printing thereby providing homogeneous luminance at the relevant area. Therefore, it is enabled to transmissively illuminate the scale marks section 21 and numerical characters section 22 of the dial plate 2 with uniform brightness, and to suppress ununiformity of light emitting luminance of the scale marks section 21 and numerical characters section 22 on the dial plate 2 from occurring, thereby improving visibility of the display device 1.

Moreover, because the guide portions 31 and 32 guide the incident light from the light sources 4 and 5 into light propagating in a direction along the first main surface 3a and second main surface 3b of the light guide body 3, a cheap vertical emission type LED is allowed to be mounted on the printed circuit board 6 for the use as each light source. Thus, an additional board for the light source is unnecessary and the structure is avoided from being complicated.

Furthermore, because the diffusion printing is applied to the rear surface of dial plate 2, it is unnecessary to provide an additional component, such as a diffusion sheet, for diffusing the light emitted from the first main surface 3a of light guide body 3, and the number of components can be suppressed from increasing.

Although the light guide body 3 is formed as being circular arc shape with certain width in plane view in response that the dial plate 2 is formed as being circular arc shape in the above-described embodiment, the light guide body used in the present invention is not limited to being circular arc in a district sense. It is appreciated that the light guide body would be applied on a merely bent or curved shape.

According to the above-described embodiment, the groove regions 13 are formed radially from the center point of the circular arc shaped light guide body 3, because the light guide body 3 is in a circular arc shape and the light sources 4 and 5 are each located at the center of the width direction of the light guide body 3. Alternatively, in the case where the light guide body 3 is not in a circular arc shape but in a merely bent or curved shape, or the light sources 4 and 5 are each located as being deviated away from the center of the width direction of the light guide body 3, it is preferred that the groove regions 13 are formed at positions and in directions as guiding light from the light sources 4 and 5 to propagate along the shape of the light guide body 3.

### DESCRIPTION OF REFERENCE NUMERALS

1; display device
2; dial plate
3; light guide body
4, 5; light sources
6; printed circuit board
7; movement
8; pointer
9; controller
10; case
11; facing plates
12; front face cover
13; groove regions
13a; reflecting surfaces
21; scale marks section
21a; scale marks
22; numerical characters section
22a; numerical characters
31, 32; guide portions

What is claimed is:

1. A display device comprising:
a light-transmissive dial plate having an indicative section arranged in a curved fashion;
a light guide body formed in a curved shape and located at a rear surface side of the dial plate so as to cover the indicative section, the light guide body having a first main surface that faces the dial plate and a second main surface that is an opposite surface of the first main surface, the second main surface being formed with a plurality of groove regions each having a reflecting surface so as to guide light along the curved shape of the light guide body; and
at least one light source mounted on a wiring board located at a side of the second main surface of the light guide body and emitting light in a substantially vertical direction relative to a mounting surface of the wiring board, wherein
the light guide body has a guide portion formed at least one end portion of the light guide body, the guide portion receives, at an entrance face, light emitted from the light source and propagating in a substantially vertical direction relative to the first main surface and the second main surface of the light guide body, and guides the received light into light propagating in a direction along the first main surface and the second main surface of the light guide body, and
the reflecting surface of each groove region reflects light from the light source to a side of the first main surface of the light guide body.

2. The display device as recited in claim 1, wherein
the indicative section is arranged in a circular arc fashion and the light guide body is formed in a circular arc shape, and
the plurality of groove regions are formed radially from a center position of the circular arc shaped light guide body.

3. The display device as recited in claim 2, wherein
the guide portion is formed by bending the end portion of the circular arc shaped light guide body toward the second main surface, and
the entrance face is formed at an end of the guide portion so as to be a plane substantially perpendicular to an optical axis direction of the light source.

4. The display device as recited in claim 3, wherein
a surface of the guide portion corresponding to the first main surface is formed with faces each having a certain angle of a critical angle or more to outer air.

5. The display device as recited in claim 1, wherein
an area on the rear surface of the dial plate corresponding to the indicative section is treated with diffusion printing to diffuse light emitted from a surface of the light guide body.

6. The display device as recited in claim 1, wherein
the reflecting surface is an inclined surface of a V-shaped groove region formed at the second main surface of the light guide body.

7. The display device as recited in claim 6, wherein
the grooved region is a groove continuously formed in a width direction of the light guide body.

8. The display device as recited in claim 7, wherein
the grooved region is formed across the width direction of the light guide body.

9. The display device as recited in claim 6, wherein
the V-shaped groove region is formed such that a depth thereof increases in accordance with an increase of a distance from the light source.

10. The display device as recited in claim 1, wherein
the light source comprises a first light source and a second light source different from the first light source, and
the light guide body has a first entrance face on which light from the first light source is incident and a second entrance face on which light from the second light source is incident.

11. The display device as recited in claim 10, wherein
the reflecting surface of each groove region is formed such that the reflecting surface reflects light from either one of the first light source and the second light source, which is relatively close to the reflecting surface in a distance via the light guide body, toward the first main surface.
